(19) United States
(12) Patent Application Publication
(10) Pub. No.: US 2013/0126280 A1
(43) Pub. Date: May 23, 2013

(54) SINGLE ABUTMENT CALIPER

(71) Applicant: Kenneth Eric Gutelius, Lake Orion, MI (US)

(72) Inventor: Kenneth Eric Gutelius, Lake Orion, MI (US)

(73) Assignee: Akebono Corporation, Elizabethtown, KY (US)

(21) Appl. No.: 13/302,320

(22) Filed: Nov. 22, 2011

(51) Int. Cl. F16D 55/227; F16D 65/18; F16D 65/00

(52) U.S. Cl. 188/73.45; 188/219.1

(57) ABSTRACT

A caliper comprising: a piston bore; one or more fingers; a bridge connecting the piston bore and the one or more fingers; a pin bore in the caliper; a guide pin bore in the caliper, the guide pin bore including a groove; and a bushing that extends into the guide pin bore so that a portion of the bushing is located inside of the guide pin bore and a portion of the bushing is located outside of the guide pin bore; wherein the bushing further extends into the groove in the guide pin bore.

### FIELD

The present teachings generally relate to a braking system that includes a compact configuration so that the resulting braking system has a reduced mass, and more specifically a disc brake that includes one pin bore on the caliper, a support bracket, and a brake pad, which result in a reduction in overall mass.

### BACKGROUND

Generally, a braking system includes a rotor, a caliper body, a support bracket, an inboard brake pad, and an outboard brake pad that are on opposing sides of the rotor. The caliper body includes a bridge, one or more fingers, and a piston bore. Typical, braking systems include a pin bore on opposing ends of the caliper body, brake pads, and support bracket for receiving a pin that secures the caliper and the brake pads on the support bracket so that the brake pads can slide on the pins to create a braking force. The brake pads are moved by a piston located in the piston bore. The piston bore further includes a fluid inlet in a closed wall, a front opening, and a cylindrical side wall that includes a seal groove located near the front opening. The brake fluid enters the closed wall of the piston bore during a pressure apply and moves the piston towards the front opening into contact with a brake pad. The brake pad slides on the pins towards the rotor and simultaneously or slightly thereafter the one or more fingers push the opposing brake pad towards the opposing side of the rotor. The brake pads slide on both of the pins so that a face of the brake pads is maintained parallel to a respective adjacent face of the rotor. Typically, during braking the rotational forces of the rotor push the brake pads radially in the direction of rotation. This radial force moves the brake pads into contact with the pins, which prevent further movement of the brake pads and assist in creating a braking force.

These current braking systems adequately provide a braking force so that movement is slowed and/or eliminated. However, current braking systems have a high mass, which adds to the overall weight of a device such as a vehicle, and increases the cost for the braking system. Current braking systems attempt to align the brake pads with the rotor using the slide pins; however, in order to maintain alignment large slide pins are required so that they do not deflect and cause uneven contact between the faces of the rotor and the faces of the brake pads. Furthermore, current braking systems rely upon a seal located in a seal groove of the piston bore for retraction of the brake pads away from the rotor so that contact between the brake pads and the rotor is reduced and/or eliminated while the brakes are in the brake off position. Examples of such braking devices are disclosed in U.S. Pat. Nos. Re32,470; 3,848,709; 4,151,899; 4,193,481; 4,225,017; 4,817,764; 5,226,510; 5,263,555; 5,526,904; 5,562,187; 5,931,267; 5,934,416; 7,275,624; and 7,849,977 all of which are expressly incorporated herein by reference for all purposes.

The present teachings reduce the overall mass of existing braking systems by removing the need for a pin and corresponding pin bore on one side of the brake pad, support bracket, and caliper. However, in removing the second pin the brake pads and caliper are only secured on one side to the support bracket and/or each other, and additional forces are placed on the remaining pin. Furthermore, without the second pin securing the caliper and brake pads on both sides to the support bracket the face of the brake pads relative to the faces of the rotor may not be in substantial alignment, which can cause taper of the brake pads, taper of the rotor, disc thickness variation (DTV), DVT growth, increase air gap, or a combination thereof. Additionally, the weight of the piston, piston bore, and brake fluid may cause the piston bore to sag so that the piston bore axis and the rotor axis are not substantially parallel, which may lead to taper of the brake pads, taper of the rotor, disc thickness variation (DTV), DVT growth, increase air gap, or a combination thereof. What is needed is a caliper with reduced mass that that does not sacrifice braking efficiency; assists in retracting the outboard brake pad so that the outboard brake pad maintains a constant air gap; self-aligns so that the caliper maintains the faces of the brake pads parallel to the faces of the rotor and the caliper resists sag; or a combination thereof. What is needed is a brake pad that maintains its position relative to the caliper, the support bracket, or both if the pin becomes broken, damaged, missing, or a combination thereof, and creates a braking force so that a device such as a vehicle can be stopped. What is further needed is a support bracket that includes one or more features that assist in maintaining the position of the brake pads; a substantially reduced mass, without sacrificing strength; or both.

### SUMMARY

The teachings herein surprisingly solve one or more of these problems by providing a braking device that includes an improved caliper, support bracket, and brake pads.

One possible embodiment of the present teachings include: a caliper comprising: a piston bore; one or more fingers; a bridge connecting the piston bore and the one or more fingers; a pin bore in the caliper; a guide pin bore in the caliper, the guide pin bore including a groove; and a bushing that extends into the guide pin bore so that a portion of the bushing is located inside of the guide pin bore and a portion of the bushing is located outside of the guide pin bore; wherein the bushing further extends into the groove in the guide pin bore.

One unique aspect of the present teachings envisions: a support bracket comprising: a support bracket comprising: (1) a tie arm, the tie arm including: a pin bore and a guide pin bore and (2) a cross arm connected to the tie arm, the cross arm including a pin bore that is substantially axially aligned with the pin bore of the tie arm so that a pin can pass through both the tie arm pin bore and the cross arm pin bore; wherein the tie arm includes ribs so that deflection of the tie arm is minimized and/or substantially eliminated during a brake apply. The ribs are located on the tie arm, the cross arm, a common region between the tie arm and the cross arm, or a combination thereof.

Another unique aspect of the present teachings include: a brake pad comprising: a friction material and a pressure plate, the pressure plate comprising: a support arm that includes: a pin bore and an abutment on an end of the support arm; and one or more projections on a side of the pressure plate opposite the friction material. The projections align with a bore in the one or more fingers of the caliper so that the brake pad is maintained in alignment with the caliper and the brake pad is substantially free of movement relative to the one or more fingers of the caliper.

Yet another unique aspect of the present teachings include: a braking system comprising: the support bracket as taught herein; a pin; a guide pin; the brake pad as taught herein in an outboard position and an inboard position; a rotor located between the brake pad in the inboard position and the brake pad in the outboard position; and the caliper as taught herein; wherein the caliper is attached to the support bracket with the pin, and the guide pin assists in maintaining the position of the caliper on the support bracket; and further wherein the brake pad in the inboard position and the brake pad in the outboard position are located inside of the caliper and the pin passes through a bore in the inboard brake pad and a bore in the outboard brake pad so that the inboard brake pad and the outboard brake pad are attached to the brake assembly.

The present teachings include a unique support bracket, brake pads, and caliper that surprisingly solve one or more of the problems discussed herein. The caliper includes one or more bushings that are disposed between the caliper and the support bracket that assist in retracting the caliper away from the support bracket, once a brake apply is complete, so that an air gap is created and contact between the brake pads and rotor is minimized. The caliper includes a groove in the pin bore, the guide pin bore, or both that receives a bushing, and the bushing receives a respective pin or guide pin. The bushing resists any sag of the caliper by providing a reactionary force so that the bore axis and the rotor axis are maintained substantially parallel relative to each other. Surprisingly the present teachings solve one or more of the problems discussed herein by providing: a caliper with reduced mass that that does not sacrifice braking efficiency; assists in retracting the outboard brake pad so that the outboard brake pad maintains a constant air gap; self-aligns so that the caliper maintains the faces of the brake pads parallel to the faces of the rotor and the caliper resists sag; a brake pad that maintains its position relative to the caliper, the support bracket, or both if the pin becomes broken, damaged, missing, or a combination thereof, and creates a braking force so that a device such as a vehicle can be stopped; a support bracket that includes one or more features that assist in maintaining the position of the brake pads; a substantially reduced mass, without sacrificing strength; or both; or a combination thereof.

### BRIEF DESCRIPTION OF THE DRAWINGS

FIG. 1 illustrates an example of a braking device of the teachings herein;

FIG. 2 is an exploded view of the breaking device as taught herein;

FIG. 3 illustrates a cross-sectional view of the breaking device of FIG. 1 along line 3-3;

FIG. 4A illustrates the alignment of the pin bore and guide pin bore between the caliper and the support bracket;

FIG. 5 illustrates the alignment of the pin bore and the guide pin bore when the caliper is attached to the support bracket;

FIG. 6 illustrates a close-up view of one possible embodiment of a support bracket;

FIG. 7 illustrates sag of the caliper of FIG. 1 along line 7-7; and

FIG. 8 illustrates one possible configuration for self-aligning the caliper to the bracket of FIG. 1 along line 8-8.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings are predicated upon providing an improved disc brake system and caliper for use with vehicles. For example, the caliper may be used with almost any vehicle (e.g. car, truck, bus, train, airplane, or the like). Alternatively, the caliper may be integrated into assemblies used for manufacturing or other equipment that require a brake such as a lathe, winder for paper products or cloth, amusement park rides, or the like. However, the present teachings are most suitable for use with a passenger vehicle (i.e. a car, truck, sports utility vehicle, or the like).

The present teachings provide an improved support bracket, caliper, brake pads, or a combination thereof, which in part or in combination reduce the overall weight of the braking system without reducing braking efficiency and maintain an air gap so that the brake pads do not contact the rotor during running and reduce fuel efficiency, pad life, rotor life, or a combination thereof. The present teachings further provide for a caliper that self-adjusts so that the caliper body, inboard brake pad, outboard brake pad, or a combination thereof are adjusted through the life of the brake pads and/or rotor so that the brake pads and the rotor maintain a substantially parallel position relative to each other in order to: reduce and/or substantially eliminate taper of the brake pads, taper of the rotor, disc thickness variation (DTV), DVT growth, increase air gap, or a combination thereof.

The braking system includes a caliper. The caliper includes a piston bore, a bridge, and one or more fingers. The bridge connects the piston bore to the one or more fingers. The fingers may include a bore (e.g., a through hole). The bore of the fingers may be any size so that the bore may accept a projection from the brake pads. The bore may accept a clip. The bore in the fingers may be used to align the brake pads. The bore in the fingers may reduce and/or eliminate radial movement of the brake pads. For example, the bore in the fingers may limit the movement, of the brake pads: in the direction of rotation, in a direction perpendicular to the direction of rotation, or both. The fingers are preferably located on an opposing side of a rotor from the piston bore. More preferably, the piston bore is on the inboard side and the fingers are on the outboard side of the caliper. The caliper may include one or more pin bores.

Preferably, the caliper includes only one pin bore. More preferably, the caliper is free of a second pin bore. The caliper includes a pin bore that projects out from the caliper. The pin bore may project out from the outboard side of the caliper. Preferably, the pin bore may project out from the inboard side of the caliper. The pin bore may be located in the bottom half of the caliper (i.e. below a line substantially parallel (i.e., a horizontal axis) to the bridge of the caliper that bisects a cross-section of the piston bore, and which is substantially perpendicular to the piston bore axis). Preferably, the pin bore is located in the top half of the caliper. More preferably, the pin bore is located substantially at the top of the caliper. The pin bore may include an axis. The pin bore may include an axis that runs through the center of the pin bore. A pin may be inserted into the pin bore along the pin bore axis. A pin may be housed in the pin bore, and the pin may extend from the inboard side of the caliper through an inboard pin bore in a support bracket and an outboard pin bore in the support bracket. The pin may be inserted through one or more pin bores in: the caliper, the support bracket, the brake pads, or a combination thereof. The pin bore may be located on the caliper so that the rotation of the rotor is moving away from the pin bore and the pin while the rotor is rotating in the forward direction. The pin bore may be located on the caliper so that the pin is in a “pull” position when the rotor is rotating in the forward direction. Preferably, the pin and pin bore are located on the caliper so that rotation of the rotor is moving towards the pin and the pin bore while the rotor is rotating in the forward direction. The pin bore may be located on the caliper so that the pin is in a “push” position when the rotor is rotating in the forward direction. The pin bore is located on the caliper so that a pin passes through the pin bore of the caliper, the brake pads, and the support bracket so that the brake pads slide along the pin during a brake apply and a brake retract. The pin bore is located so that brake pads sliding on the pin located in the pin bore are maintained substantially parallel to the rotor.

The pin (i.e., a member that the brake pads slide on) may extend through a pin bore in an inboard brake pad, an outboard brake pad, or both. The caliper may include an outboard pin bore. Preferably, the caliper is free of an outboard pin bore. The caliper may be free of any other pin bores located in the top half of the caliper (i.e. above a line substantially parallel (i.e., a horizontal axis) to the bridge of the caliper that bisects a cross-section of the piston bore, and which is substantially perpendicular to the piston bore axis) of the caliper. More preferably, the caliper may be free of pin bores located in the top half of the caliper on the inboard side of the caliper. The pin and/or the guide pin may fit securely in the pin bore and/or the guide pin bore respectively. The pin bore and/or guide pin bore may be larger than the respective pin and/or guide pin. The pin and/or guide pin may move within the pin bore and/or guide pin bore. The bushing may create a reactionary force that presses the pin against a wall of the pin bore so that the caliper self-adjusts and is held in position relative to the support bracket. The caliper may include other bores in the caliper.

The caliper includes a guide pin bore. The guide pin bore may be located on the outboard side of the caliper. Preferably, the guide pin bore may be located on the inboard side of the caliper. More preferably, the guide pin bore and the pin bore may be located on the same side of the caliper. The guide pin bore may be located in the top half of the caliper (i.e. above a line parallel to the bridge of the caliper that bisects a cross-section of the piston bore, and which is perpendicular to the piston bore axis). Preferably, the guide pin bore may be located in the bottom half of the caliper. More preferably, the guide pin bore may be located substantially at the bottom of the caliper. The guide pin bore and the pin bore may be located on opposite sides of the caliper (i.e., on opposite sides of a line (i.e., vertical axis) that is perpendicular to both the line parallel to the bridge of the caliper and the piston bore axis). Preferably, the guide pin bore and the pin bore may both be located on the same side of the caliper (e.g., both inboard side or both outboard side). The guide pin bore and the pin bore may be located on the same half of the caliper (e.g. top half, bottom half, or middle). Preferably, the guide pin bore and the pin bore are located on opposite halves of the caliper. Preferably, the guide pin bore and the pin bore are located substantially diagonally opposite each other on the same side of the caliper. The guide pin bore may include an axis. The guide pin bore may include an axis that runs through the center of the guide pin bore. A guide pin may be inserted into the guide pin bore along the guide pin bore axis. A guide pin may be housed in the guide pin bore, and the guide pin may extend from the inboard side of the caliper through an inboard pin bore and connect to the support bracket. The guide pin bore includes a guide pin. The guide pin may pass entirely through the guide pin bore and into a guide pin bore located in the support bracket so that the caliper does not rotate radially, relative to the rotor. The guide pin may extend from the outboard side of the caliper to the inboard side of the caliper. Preferably, the guide pin extends from the inboard side of the caliper to the inboard side of the support bracket where the guide pin connects the caliper to the support bracket. The guide pin bore may include a groove.

The guide pin bore may include a groove. The pin bore may include a groove. The groove may be located at any location along the guide pin bore and/or the pin bore. The groove may be a recess in the inside circumference of the guide pin bore. The groove may be annular in shape. The groove may be transverse to the axis of the pin and/or the guide pin respectively and surround the axis of the pin and/or the guide pin respectively. Preferably, the groove may be located in an end region of the guide pin bore and/or the pin bore (i.e., not located in the center of the guide pin bore and/or pin bore). More preferably, the groove is located in an end region of the guide pin bore and/or pin bore located proximate to a support bracket. The groove may include an inner wall and an outer wall. The outer wall may be located closer to the support bracket than the inner wall. The inner wall and the outer wall include both a height and a width. The outer wall may be taller than the inner wall. Preferably, the inner wall is taller than the outer wall (i.e., the inner wall extends further into the guide pin bore and/or the pin bore than the outer wall). The outer wall of the groove may be shorter than the inner wall of the groove so that a bushing may be installed in the groove and extend around the outer wall of the groove into the groove. The groove may have a width (i.e., the distance between the inner wall and the outer wall). The width of the groove may be about 0.5 mm or more, about 1.0 mm or more, or about 1.5 mm or more. The width of the groove may be about 4.0 mm or less, about 3.0 mm or less, or about 2.5 mm or less. The width may be between about 1.0 mm and about 3.0 mm and preferably between about 1.8 mm and about 2.2 mm (i.e., about 2.0 mm). The inner wall may have a height (i.e., the distance from the top of the wall to the bottom of the groove). The height of the wall may be about 0.5 mm or more, about 1.0 mm or more, or about 1.2 mm or more. The height of the inner wall may be about 3.0 mm or less, about 2.0 mm or less, or about 1.8 mm or less. The height of the inner wall may be about 1.0 mm and about 3.0 mm and preferably between about 1.2 mm and about 1.8 mm (i.e., about 1.5 mm). The inner wall and the outer wall may have a height ratio. The ratio of the inner wall height to the outer wall height may be about 1:1.1 or more, about 1:2 or more, about 1:2.5 or more. The ratio of the inner wall height to the outer wall height may be about 1:10 or less, about 1:5 or less, or about 1:3 or less. The ratio of the inner wall height to the outer wall height may be between about 1:2 and 1:3 (i.e., about 1:2.67).

The inner wall, the outer wall, the groove, or a combination thereof may be of any shape and size so that a bushing may be located in the groove so that the bushing self-aligns the caliper. The inner wall, the outer wall, the groove, or a combination thereof may be square. The inner wall, the outer wall, the groove, or a combination thereof may include chamfered edges (i.e., the edges are cut at an angle so that they are free of sharp corners). The chamfered edges may be cut at any angle so that the edges of the inner wall, the outer wall, the groove, or a combination thereof do not cut the bushing when it is installed.

The guide pin bore, the pin bore, or both may include a bushing. Preferably, the guide pin bore includes a bushing. The bushing has an annular shape. A cross-section of the bushing may be toroidally shaped. The bushing may be located between the guide pin bore and the guide pin. The bushing may be located between the pin and the pin bore. A portion of the bushing may be located between the caliper and the support bracket. The bushing may self-adjust the caliper relative to the support bracket. The bushing may be any bushing so that the guide pin, the pin, or both are held in the respective bores. The bushing may be any bushing so that the caliper may adjust from side to side during a brake apply (i.e., in a direction perpendicular to the bore axis). The bushing may be any bushing so that the caliper moves with the rotor so that the brake pads are substantially parallel to the rotor during a brake apply, a brake retract, running, braking, or a combination hereof. The bushing may create a moment against a pin, a guide pin, or both so that any sag related to the weight of the caliper is counteracted and the caliper is aligned relative to the support bracket, the rotor, or both. For example, the bushing may create an offsetting force (e.g., a force in the opposite direction of gravity) that compensates for any sag caused by the weight of the body so that the bore axis of the body maintains a parallel relationship to the axis of the rotor. The moment created by the bushing may be large enough to counteract any sag of the caliper. The moment created by the bushing may counteract all or a portion of the sag of the caliper. The bushing may move the caliper, the inboard brake pad, the outboard, brake pad, or a combination thereof in a direction parallel to the axis of the rotor during a brake apply, a brake retract, braking, or a combination thereof (i.e., axially along an axis of the rotor). The bushing may actively move the caliper axially along an axis of the rotor after a brake apply so that air gap is maintained on both sides of the rotor reducing DVT, DVT growth, taper, or a combination thereof.

The bushing may be free of extension though the pin bore, the guide pin bore, or both so that the caliper and the support bracket directly oppose each other without any intervening parts. The bushing may include a portion that extends onto the groove in the pin bore and/or the guide pin bore. The bushing may include a portion that is located on the outside of the pin bore and/or guide pin bore. Preferably, the bushing may extend through a portion of the pin bore, the guide pin bore, or both and out of the pin bore, the guide pin bore, or both so that at least a portion of the bushing is located between the caliper and the support bracket. The bushing may extend through a portion of the pin bore, the guide pin bore or both so that during a brake apply the bushing is compressed and after a brake apply the bushing assists in moving the caliper away from the support bracket. The bushing may be smooth. The bushing may include contours. The bushing may include one or more ribs for gripping a pin and/or guide pin. The bushing may include a generally “U” shaped portion that extends into the pin bore and/or guide pin bore and around outer wall so that at least a portion of the bushing is located within the groove. The bushing may include a generally “L” shaped portion that extends into the groove in the pin bore and/or the guide pin bore. The shape of the bushing may be any shape so that the bushing may accept a pin and/or a guide pin.

The pin and/or guide pin may be installed directly into the respective pin bore and/or guide pin bore. The guide pin may have a cantilever connection with the support bracket. For example, the guide pin may attach to the support bracket and extend axially away from the support bracket, relative to the rotor, so that the guide pin attaches to the guide pin bore of the caliper housing. The pin bore and/or guide pin bore may include a bushing and then the respective pin and/or guide pin may be installed so that the caliper is attached to the support bracket via the pin and/or guide pin. The pin bore and/or guide pin bore may substantially axially align with the corresponding pin bore and/or guide pin bore in the support bracket. Preferably, the center of the pin bore and/or the center of the guide pin bore of the caliper and the support bracket are not in substantial alignment. For example, when the caliper is not attached to the support bracket, the distance between the pin bore and the guide pin bore of the support bracket may be greater than the distance of the pin bore and the guide pin bore of the caliper. In another example, a pin may be installed so that the pin extends from the pin bore in the caliper into the pin bore in the support bracket, and upon the installation of the pin the center axes of the caliper guide pin bore and the support bracket guide pin bore may not align, may be in a different plane, or both.

The distance between the center of the pin bore and the center of the guide pin bore of the caliper in the horizontal direction (i.e. a direction from left to right when the caliper is viewed so that the face of the piston and piston bore are visible and the bridge is located over the piston and/or piston bore) may be about 90 mm or more, about 95 mm or more, preferably about 100 mm or more, more preferably about 105 mm or more, or even more preferably about 109 mm or more. The distance between the center of the pin bore and the center of the guide pin bore of the caliper, in the horizontal direction, may be about 150 mm or less, about 125 mm or less, or preferably about 110 mm or less. The distance between the center of the pin bore and the center of the guide pin bore of the caliper in the horizontal direction may be between about 90 mm and about 130 mm, preferably between about 100 mm and about 120 mm (i.e., about 109.3 mm±0.25). For example, the horizontal direction may be represented by an “X” axis on a Cartesian coordinate system. The guide pin bore and the pin bore of the caliper may be located in separate planes (e.g., one plane may be located above the other plane, thus, there may be a vertical distance between the respective planes that extend from the center of the respective bores). The distance between the plane extending from the center of the pin bore and the plane extending from the center of the guide pin bore of the caliper in the vertical direction (i.e., a direction extending down and away from the bridge of the caliper when the caliper is viewed so that the face of the piston and piston bore are visible and the bridge is located over the piston and/or piston bore) may be about 35 mm or more, about 40 mm or more, about 45 mm or more, or preferably about 48 mm or more. The distance between the plane extending from the center of the pin bore and the plane extending from the center of the guide pin bore of the caliper in the vertical direction may be about 90 mm or less, about 75 mm or less, about 60 mm or less, preferably about 55 mm or less, or more preferably about 50 mm or less. The distance between the plane extending from the center of the pin bore and the plane extending from the center of the guide pin bore of the caliper in the vertical direction may be between about 40 mm and about 65 mm, or preferably between about 45 mm and about 55 mm (i.e. about 48.7 mm±0.25). For example, the vertical direction may be represented by an “Y” axis on a Cartesian coordinate system. The direct distance between the center of the pin bore and the center of the guide pin bore may be the most direct that that connects the centers of the respective bore. The direct distance (i.e. a line that extends both vertically and horizontally between the center of the guide pin bore and the center of the pin bore) may have a length of about 100 mm or more, about 110 mm or more, or preferably about 120 mm or more. The direct distance between the center of the pin bore and the center of the guide pin bore may be about 180 mm or less, about 150 mm or less, or preferably about 130 mm or less. The direct distance between the center of the pin bore and the center of the guide pin bore may be between about 105 mm and about 145 mm or preferably between about 115 mm and about 135 mm (i.e. about 119.66±0.75 mm). For example, the direct distance may be represented by a “Z” axis on a three-dimensional Cartesian coordinate system.

The pin bore, the guide pin bore, or both of the support bracket may have a soft fit with the pin, the guide pin, or both (i.e., the pin may have room to move from side to side within the respective bore. Preferably, the pin bore, the guide pin bore, or both of the support bracket may have a “hard” fit with the pin, guide pin, or both so that once the respective pin and/or guide pin is installed in the support bracket the installed pin and/or guide pin is free of “play” in the respective bore (i.e., the pin cannot be moved from side to side within the bore). The connection between the pin and the pin bore; the guide pin and the guide pin bore, or both of the support bracket may be metal to metal. The pin bore, the guide pin bore, or both of the caliper may have a “hard” fit with the pin, guide pin, or both so that once the respective pin and/or guide pin is installed the free of “play” in the respective bore (i.e., the pin cannot be moved from side to side within the bore). Preferably, the pin bore, the guide pin bore, or both of the caliper may have a soft fit with the pin, the guide pin, or both. For example, the pin may have room to move from side to side within the respective bore. In another example, the pin bore, the guide pin bore, or both may include a bushing, which may allow the pin, the guide pin, or both to move within the respective bore. The guide pin bore, the pin bore, or both of the support bracket may be smaller than the guide pin bore, the pin bore, or both of the caliper. A hard connection as discussed herein is a metal to metal connection. A hard connection as discussed herein may be a metal to metal connection. A soft connection as discussed herein may include a bushing between the bore and the respective pin. The guide pin bore, the pin bore, or both of the caliper may be about 0.05 mm or larger, about 0.1 mm or larger, about 0.2 mm or larger, or even about 0.3 mm or larger than the corresponding guide pin bore, the pin bore, or both of the support bracket. The guide pin bore, the pin bore, or both of the caliper may be about 1.0 mm or less, about 0.8 mm or less, or about 0.5 mm or less than the corresponding guide pin bore, the pin bore, or both of the support bracket. The bushing of the pin bore and/or guide pin bore may be compressed at all times. For example, the guide pin bore may be compressed during a brake off, a brake apply, a brake retract, or any time therebetween. The pin, guide pin, or both, when installed, may be located “off center.” For example, the pin, guide pin, or both may be located proximate to or touching an edge of a pin bore, a guide pin bore, or both. The bushing may be compressed in a direction along the axis of the respective pin bore; the bushing may be compressed in a direction perpendicular to the axis of the respective pin bore (i.e., in a direction parallel to the face of the brake pads and/or rotor); or both.

The bushing may exert a force on the caliper, the support bracket, or both. Preferably, the bushing produces a force so that the fingers of the caliper move axially, in relationship to the rotor, away from the support bracket the rotor, or both. The bushing may exert a force so that the bore axis and the rotor axis are maintained substantially parallel. The bushing may be made of any material that is compressible. The bushing may be made of any material that elastically deforms. The bushing may be made of any material that is substantially free of plastic deformation. The bushing may be made of any material that is resistant to dirt and fluids. Preferably, the bushing is resistant to brake fluid. The bushing may be made of a polymeric material. Preferably, the bushing may be made of an elastomeric material. More preferably, the bushing may be made of: rubber (synthetic; Ethylene Propylene Diene Monomer; styrene alkadiene block copolymers; elastomers; modified polyolefins; the like; or a combination thereof). The bushing may be made of any material that may be compressed 100 times or more, 1,000 times or more, 10,000 times or more 100,000 times or more, or even 500,000 times or more and still elastically deform so that a force is exerted on the caliper. The bushing may be made of any material that may be placed under constant compression and remain elastically deformable (i.e., continuously exert a reactionary force).

The bushing may create an axial force upon the caliper, in a direction along an axis of the rotor, a force perpendicular to the axis of the rotor, or both of about 10 N or more, about 25 N or more, preferably about 50 N or more, or more preferably about 60 N or more when new. The bushing may create a force in the axial direction, relative to the rotor, a force perpendicular to the axis of the rotor, or both of about 150N or less, about 125 N or less, preferably about 100 N or less, or about 85 N or less when new. For example, the bushing may create a force of between about 60 and 90 N when new (i.e. about 75 N). The bushing may exert the same force when the bushing is new and when the bushing is worn. However, the elasticity of the bushing may vary over time. The bushing may exert a force in the axial direction, relative to the rotor, a force perpendicular to the axis of the rotor, or both of about 10 N or more, about 20 N or more, preferably about 25 N or more, more preferably about 30 N or more in a fully worn condition. The bushing may exert a force in the axial direction, relative to the rotor, a force perpendicular to the axis of the rotor, or both of about 80 N or less, about 60 N or less, about 50N or less, or about 40 N or less when the bushing is in the fully working condition. For example, the bushing may exert a force in the axial direction, relative to the rotor, a force perpendicular to the axis of the rotor, or both of about 30 N to about 45 N (i.e., about 35 N). It is contemplated that more than one bushing may be employed and each bushing may exert a force as discussed herein. The bushing may be permanently installed in the guide pin bore. Preferably, the bushing may be removable so that a new bushing may be installed when the brake pads are changed.

The caliper may include two or more brake pads. Preferably, the caliper includes an inboard brake pad and an outboard brake pad. The brake pads may be substantially mirror images of each other. The brake pads include a pressure plate and friction material. The brake pads may each include two support arms. Preferably, the brake pads may include one support arm. The brake pads may be free of a second support arm. The support arms may be an extension of the pressure plate. The support arms may include friction material. Preferably, the support arms may be free of friction material.

The brake pads may include a pin bore. The pin bores may be located anywhere in the brake pads. The pin bores may be located at any location on the brake pads so that a pin may be placed in the pin bores. The pin bores may be located at any location on the brake pads so that the pin bores may be used hold the brake pads in place. Preferably, the pin bores are located in each respective support arm. The brake pads may be free of a second pin bore. The pin bore may be any shape and size so that the pin bore receives a pin and the brake pads move along the axis of the pin toward the rotor during a brake apply and away from a rotor during a brake retract. The pin bore may be a partial pin bore. For example, the pin bore may be “U” or “C” shaped. Preferably, the pin bore completely surrounds the pin. For example, the pin bore may be a square, a rectangle, a circle, an oval, or a combination thereof so that the pin has the pin bore on every side (i.e., the pin is completely surrounded). The pin may snugly fit into the pin pore of the brake pad. The pin may be free of “play” when placed in the pin bore. For example, during a brake apply the pin bore may be in contact with the pin and the “pull” or “push” on the pin may occur without any movement of the brake pad in the direction of rotation of the rotor. The brake pads during a brake apply may move perpendicular to the axis of the pin, and the pins and/or abutment may prevent further radial movement of the brake pads. The brake pads may move along an axis, and in a direction perpendicular to the axis of the pin and into contact with the abutment of the support bracket so that the abutment receives all or a majority of the brake pad's force in a direction perpendicular to the axis of the pin. The pin may deflect during a brake apply so that the abutment of the support bracket receives the radial forces during a brake apply. The pin may be free of deflection during a brake apply so that the pin receives the radial forces during a brake apply. The shape of the brake pads may mirror the corresponding shape of the support bracket.

The brake pads may include an abutment. The abutment may be any surface so that the brake pad and the support bracket include a complementary surface. The abutment may be a curved surface. The abutment may include a point or a peak. Preferably, the abutment may be a flat surface. The abutment may be located at any location on the brake pad. Preferably, the abutment may be a portion of the support arm. The abutment may be free of contact with the support bracket during normal conditions. The abutment may contact the support bracket during running. The abutment may contact the support bracket during a brake apply. The force of a brake apply may cause the pin to deflect so that the abutment of the brake pad contacts the abutment of the caliper. The abutment may contact the support bracket if the pin is broken or the pin is not placed though the pin bores. The abutment may minimize, eliminate, or both radial movement, relative to the rotor, of the brake pads during a brake apply, a brake retract, or any time therebetween if the pin is broken, not replaced, or both. The abutment may be used to create a braking force in the event that the pin is broken or not replaced. For example, in the event that the brake pads no longer include a pin the abutment will contact the support bracket so that the brake pads are maintained in the respective braking position during a brake apply, braking, or both. The abutment may contact the support bracket during a brake apply where the pin and/or guide pin is located in the pin bore, thus, reducing the load that is placed on the support bracket so that rotation of the brake pad is minimized, eliminated, or both. In addition to an abutment the brake pads may include one or more other features to reduce and or eliminate movement of the brake pad without or without attachment via pins.

Each brake pad may include a projection. The projection may be located anywhere on the brake pad. Preferably, the one or more projection is located on the pressure plate of the brake pad. More preferably, the one or more projections are located on the side of the pressure plate opposite the friction material. The projections may be the same size and shape. Preferably the projections are of different sizes and shapes. The number of projections located on the pressure plate may vary. The location of the projections on the pressure plate may vary. The projections may be round, oval, square, diamond, include holes, include slots, include a hook, or a combination thereof. Preferably, the projections may be of any size and shape so that they assist in reducing and/or substantially eliminating movement of the brake pads (e.g., horizontal, vertical, radial, or a combination thereof). The projections may contact the piston. The projections may contact a clip. The projections may secure a clip to the pressure plate of the brake pad. The projections may contact the fingers of the caliper. The projections may align with a bore in the fingers of the caliper. The outboard brake pad may include two projections on the pressure plate and the two projections may have a different size and shape so that radial movement of the brake pad is reduced, substantially eliminated, or both. During a brake apply, a brake retract, or both the projections may be moved into contact with edges of the bore in the finger's so that radial movement of the brake pad is reduced and/or substantially eliminated.

The inboard brake pad and the outboard brake pad may be substantially mirror images of each other. However, the inboard brake pad and the outboard brake pad may be different from each other. The inboard brake pad may include a clip (i.e., inner clip) attached to the pressure plate. The inner clip may engage the piston so that during a brake apply, a brake retract, or a time therebetween the inboard brake pad moves with the piston. The inner clip may assist in maintaining alignment of the inner brake pad. For example, the inner clip may assist in maintaining the inner brake pad substantially perpendicular to the rotor so that during a brake apply the brake pad and/or rotor are evenly worn. The inner clip may assist in preventing movement of the inner brake pad (e.g., horizontal, vertical, radial, or a combination thereof).

The outboard brake pad may include one or more clips. For example, the outboard brake pad may include an outer clip, an outer biasing clip, or both. The outer clip may be used to attach the brake pad to the caliper. Preferably, the outer clip may be attached to the brake pad via the projections and may be attached to the fingers of the caliper so that during a brake retract the fingers and the brake pad move axially away from the rotor. The outer-clip may attach to the one or more fingers of the caliper through one or more engagement portions in the fingers (i.e. bores in the fingers). The outer clip may attach the outer biasing clip to the brake pad, the fingers of the caliper, or both. The outer clip may orient the outer biasing clip relative to the brake pad, the fingers of the caliper, or both.

The outboard brake pad may include an outer biasing clip attached to the pressure plate. The outer biasing clip may be an anti-rattle clip. The outer biasing clip may engage one or more fingers of the caliper so that during a brake apply, a brake retract, or any time therebetween the inboard brake pad moves with and/or maintains orientation due to contact with the one or more fingers. The outer clip may bias the outer brake pad. The outer clip may move the brake pad radially down, relative to the caliper bridge. The outer clip may orient the caliper up, relative to the brake pad. The outer clip may orient the brake pad, the caliper, or both so that the brake pads maintain a substantially parallel to the rotor so that drag, DVT growth, or both are substantially minimized, eliminated, or both. The outer clip may orient the outer brake pad relative to the caliper so that the brake pad is held securely in place. The outer clip may orient the outer brake pad so that the clip holds the brake pad in place. The outer biasing clip may bias the caliper against sag of the caliper. The outer biasing clip may assist the bushing in the pin bore, the guide pin bore, or both in counteracting sag so that the caliper is self-aligned relative to the support bracket. The outer clip may create a moment in the direction opposite the sag of the caliper. The outer clip may counteract all or a portion of the sag of the caliper. The outer clip may create a moment that in conjunction with a moment created by the one or more bushings counteracts the sag of the caliper. The outer biasing clip may provide a reaction force to a side of a finger so that the body is lifted and is self-aligned.

The brake pad may further include one or more locators. The locator may be located anywhere on the brake pad. Preferably, the locator is located on an edge of the brake pad. More preferably, the locator is located on an edge of the pressure plate of the brake pad (i.e., not located on a face of the brake pad). The locator may be located on the bottom edge of the pressure plate (e.g., the edge farthest from the caliper bridge). Preferably, the locator may be located on the top edge of the pressure plate (e.g., the edge closest to the bridge of the caliper). The locator may be of any size and shape so that the locator assists in minimizing and/or eliminating radial movement of the brake pads. The locator during a brake apply may be moved into contact with the bridge of the caliper so that radial movement (e.g., movement vertically towards the bridge and or horizontally in the direction of rotation) is substantially reduced and/or eliminated. The locator may include a height. The height of the locator may be any height so that radial movement of the brake pads is reduced an/or eliminated during a brake apply. The height of the locator may be any height so that the locator is free of contact with the bridge during running, normal braking conditions, high pressure braking conditions, braking conditions where the pin is in the pin bore of the brake pads, or a combination thereof. The height of the locator may be about 0.1 mm or more, about 0.2 mm or more, or even about 0.3 mm or from the top of the pressure plate (i.e., a plane of the pressure plate that is consistent with the line and/or curvature of the pressure plate) to the highest point of the locator. The height of the locator may be about 1.5 mm or less, about 1.0 mm or less, or about 0.5 mm or less from the top of the pressure plate to the highest point of the locator. The height of the locator may be about 0.1 to about 1.0 mm or even about 0.2 to about 0.5 mm from the top of the pressure plate to the highest point of the locator. The locator may be on an opposite edge of the pressure plate as a retention feature.

The brake pads may include retention features so that the brake pads are maintained within the caliper in the event that the pin is not installed in the brake pad or the pin breaks. The retention features may be generally “U” shaped or “C” shaped. The retention features may include one or more retention arms and a recess and/or channel that form an abutment surface. The retention arms form a channel and/or recess between the arms. Preferably, each brake pad includes two retention arms with a channel and/or recess located between the two retention arms. The recess and/or channel may include an abutment surface. The abutment surface may be complementary to a surface of a support bracket. The retention arms may be located on either side of a surface of a support bracket. The retention features may be located at any location on a pressure plate of a brake pad. The retention features may be located in a central region of a pressure plate. The retention features may be located in an end region of a pressure plate. Preferably, the retention features are located in an end region of the pressure plate opposite the support arm. More preferably, the retention feature is located on the opposite edge of the pressure plate and in a region opposite the support arm. For example, the retention feature may be on the bottom edge of the brake pad and the support arm located on a top edge of the brake pad. The retention features may contact an abutment of the support bracket so that the brake pad is maintained in the brake system in the event that the pin breaks, is not replaced, is bent, does not retain the brake pad in place, or a combination thereof.

The braking system includes a support bracket. The caliper connects to the support bracket and the support bracket connects the caliper to the knuckle. The support bracket includes a tie arm and a cross arm. The support bracket may be free of a second cross arm. The support bracket may be free of a second tie arm. The support bracket may generally form an “L” shape. The tie arm includes at least two bores for attaching the support bracket to the knuckle. The tie arm includes at least one pin bore and at least one guide pin bore. The pin bore and the guide pin bore of the support bracket may be located a distance apart. The pin bore and guide pin bore of the support bracket may be any distance apart so that the caliper may attach to the support bracket. The guide pin bore and the pin bore of the support bracket and the caliper may be any distance apart so that the caliper and the support bracket may be attached together. The guide pin bore and the pin bore of the support bracket and the caliper may be any distance apart so that when the caliper is attached to the support bracket the one or more bushings are compressed. The distance between the center of the pin bore and the center of the guide pin bore of the support bracket may be greater than the distance between the center of the pin bore and the center of the guide pin bore of the caliper so that the bushing is compressed at all times. The guide pin bore and the pin bore of the support bracket and the caliper may be any distance apart so that when the caliper is attached to the support bracket the caliper in a state of tension, a state of compression, or a state therebetween. The guide pin bore and the pin bore of the support bracket, from center to center, may be spaced further apart than the guide pin bore and the pin bore of the caliper so that the caliper is in a state of compression once attached to the support bracket.

The distance between the center of the pin bore and the center of the guide pin bore of the support bracket in the horizontal direction (i.e. a direction from left to right when the support bracket is viewed so that the pin bore is located above the guide pin bore, and the pin bore is located to the left of the guide pin bore) may be about 90 mm or more, about 95 mm or more, preferably about 100 mm or more, more preferably about 105 mm or more, or even more preferably about 109 mm or more. The distance between the center of the pin bore and the center of the guide pin bore of the caliper, in the horizontal direction, may be about 150 mm or less, about 125 mm or less, or preferably about 110 mm or less. The distance between the center of the pin bore and the center of the guide pin bore of the caliper in the horizontal direction may be between about 90 mm and about 130 mm, preferably between about 100 mm and about 120 mm (i.e., about 110.0 mm±0.25). For example, the horizontal direction may be represented by an “X” axis on a Cartesian coordinate system. The guide pin bore and the pin bore of the support bracket may be located in separate planes (e.g., one plane may be located above the other plane, thus, there may be a vertical distance between the respective planes that extend from the center of the respective bores). The distance between the plane extending from the center of the pin bore and the plane extending from the center of the guide pin bore of the support bracket in the vertical direction (i.e., a direction extending up and away from the cross arm and the tie arm when the support bracket viewed so that the pin bore is located above the guide pin bore, and the pin bore is located to the left of the guide pin bore) may be about 35 mm or more, about 40 mm or more, about 45 mm or more, or preferably about 48 mm or more. The distance between the plane extending from the center of the pin bore and the plane extending from the center of the guide pin bore of the caliper in the vertical direction may be about 90 mm or less, about 75 mm or less, about 60 mm or less, preferably about 55 mm or less, or more preferably about 50 mm or less. The distance between the plane extending from the center of the pin bore and the plane extending from the center of the guide pin bore of the caliper in the vertical direction may be between about 40 mm and about 65 mm, or preferably between about 45 mm and about 55 mm (i.e. about 49.0 mm±0.25). For example, the vertical direction may be represented by a “Y” axis on a Cartesian coordinate system. The direct distance between the center of the pin bore and the center of the guide pin bore may be the most direct that that connects the centers of the respective bore. The direct distance between the center of the pin bore and the center of the guide pin bore of the support bracket (i.e. a line that extends both vertically and horizontally between the center of the guide pin bore and the center of the pin bore) may have a length of about 100 mm or more, about 110 mm or more, or preferably about 120 mm or more. The direct distance between the center of the pin bore and the center of the guide pin bore of the support bracket may be about 180 mm or less, about 150 mm or less, or preferably about 130 mm or less. The direct distance between the center of the pin bore and the center of the guide pin bore of the support bracket may be between about 105 mm and about 145 mm or preferably between about 115 mm and about 135 mm (i.e. about 120.42±0.75 mm). For example, the direct distance may be represented by an “Z” axis on a three-dimensional Cartesian coordinate system. The at least one guide pin bore is located anywhere along the length and/or width of the tie arm so that the tie arm can be connected to the caliper. Preferably, the guide pin bore is located in an end region. The guide pin bore may be of any size and shape so that a fastener may be used in conjunction with the guide pin bore to connect the support bracket to the caliper. The guide pin bore may be located on the inboard side of the support bracket. The guide pin bore may be partially elevated above the tie arm. About 50 percent or more, about 60 percent or more, about 70 percent or more, about 80 percent or more, or even about 90 percent or more of the guide pin bore may be elevated above the tie arm. For example, 50 percent of the guide pin bore may be located above the tie arm (i.e., the center of guide pin bore is coplanar with the tie arm). The guide pin bore may support a brake pad so that the brake pad does not radially rotate down (i.e., in the direction of the support bracket).

The pin bore may be located at any location along the length and/or width of the tie arm. Preferably, the pin bores are located on only one end of the tie arm. The pin bore may be of any size and shape so that a fastener may be used to attach a caliper and/or brake pads to the support bracket. The pin bore may be fully or partially elevated above the tie arm and the cross arm. About 60 percent or more, about 70 percent or more, about 80 percent or more, or even about 90 percent or more of the pin bore may be elevated above the tie arm, the cross arm, or both. Preferably, about 95 percent or more of the pin bore is elevated above the tie arm and/or the cross arm. The pin bore may be located entirely above the guide pin bore. The tie arm and the cross arm are connected. The tie arm and the cross arm may be substantially perpendicular to each other in a relaxed state, in a state of compression, in a state of tension, or a combination thereof. Preferably, the cross arm and the tie are connected and form a substantially right angle. The angle between the tie arm and cross arm may vary by about ±3 degrees or less, about ±2 degrees or less, or preferably, about ±1 degree or less during a brake apply.

The cross arm may include one or more attachment features so that a caliper, brake pads, or both may be attached to the support bracket. The cross arm includes one or more pin bores. Preferably, the cross arm includes one pin bore, and shares one pin bore with the tie arm. The pin bores may be located at any location along the length and/or width of the cross arm. The pin bores of the cross arm may be substantially axially aligned so that a pin can pass through both pin bores. The pin bores may be axially aligned. For example, a pin may pass through both support bracket pin bores and a caliper pin bore so that the pin connects the caliper to the support bracket. In another example, a pin may be passed through a pin bore of the caliper, through a first pin bore of the support bracket, through both brake pads, and into the second pin bore of the support bracket. The cross arm may include one or more abutments. The cross arm may include one long abutment. The abutment may be located in a central region along the cross arm. The abutment may face a rotor. The abutment may be of any size and shape so that when brake pads contact the abutment the brake pad's movement is reduced and/or eliminated. The abutment may have a complementary shape to a support arm abutment of a brake pad. The force applied to the brake pads may be transferred to the abutment of the cross arm so that the pin is free of deflection during a brake apply. The force applied to the brakes may be transferred to the abutment of the cross arm so that deflection of the pin is minimized and/or eliminated. The tie arm, the cross arm, or both may include one or more ribs.

The ribs may be any additional material that strengthens the support bracket. The ribs may be any shape and/or size that provides additional strength to the support bracket. The ribs may be disposed vertically on the support bracket. The ribs may be disposed horizontally on the support bracket. The ribs may be disposed at an angle on the support bracket (i.e., a direction between vertical and horizontal). The ribs may be strips. The ribs may be located along the outside edges of the support bracket. Preferably, the ribs are located in regions of the support bracket that experience the most stress. The ribs are most preferably, located in the corner regions of the support bracket (i.e., where the cross arm and tie arm connect). The ribs may minimize deflection. The ribs may minimize deflection when they are placed in tension. The ribs may minimize deflection when they are placed in compression. The ribs may minimize deflection in tension, compression, or both.

The support bracket may include a retention feature. The retention feature may include a complementary surface. The retention feature may include more than one complementary surfaces. The retention feature may include three complementary surfaces. The retention feature may include an abutment. The complementary surfaces may be abutments. The support bracket retention feature may include a top and two sides. The retention feature may be located proximate to the guide pin bore. The retention feature may include the guide pin bore or vice versa. The retention feature may be any elevated feature that the retention feature of the brake pad may mate with so that movement of the brake pad is minimized and/or eliminated. The retention feature of the support bracket may be of any size and shape. Preferably, the retention feature may be sized accordingly with the size of the retention feature of the brake pad so that the retention feature of the brake pad matingly engages the retention feature of the support bracket. The retention feature of the brake pad may be larger than the retention feature of the support bracket so that the retention feature of the support bracket fits into the retention feature of the brake pad and the brake pad may move. The retention feature of the brake pad may be substantially the same size as the retention feature of the support bracket so that the retention feature of the support bracket fits into the retention feature of the brake pad and the brake pad is substantially free of movement. The retention feature of the support bracket and the retention feature of the brake pad may minimize and/or eliminate movement of the brake pad in case the pin is broken, removed, lost, forgotten to be placed back in, bent, damaged, or a combination thereof.

The caliper, brake pads, rotor, and support bracket as discussed herein all are combinable to form a reduced weight braking assembly. The performance of the brake assembly as discussed herein is free of adverse effects due to thermal expansion. For example, the support bracket when heated does not put the brake pads in tension because the brake pads are only attached at one end. The brake assembly of the present teachings is free of the brake pads tying. For example, because the brake pads are only connected at one end the ends of the brake pads are not moved at different rates, thus, locking the brake pads on the pins. In another example, the brake pads are not susceptible to tying due to deflection of the pin since there is no second pin, which ties the ends of the brake pads during movement.

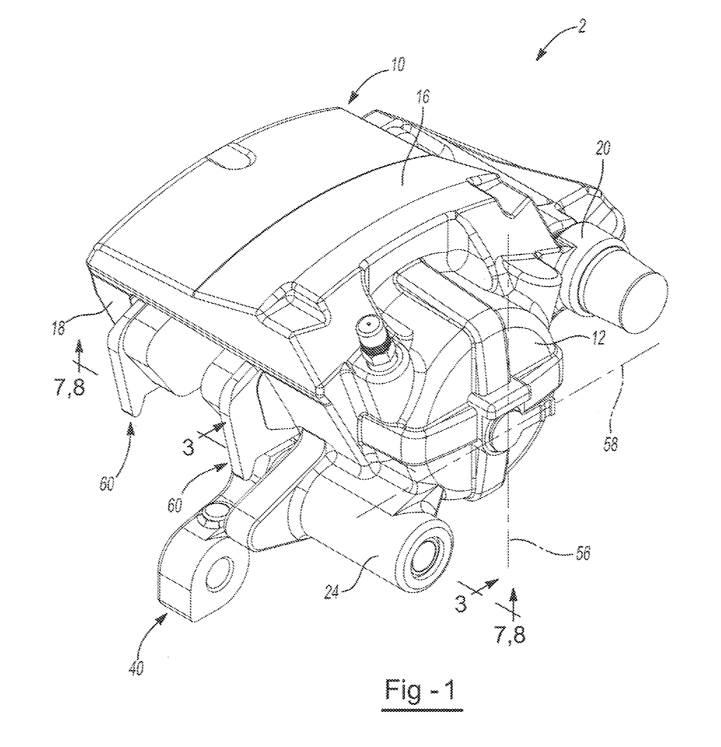

FIG. 1 illustrates one embodiment of the brake assembly 2 assembled with the caliper 10, the support bracket 40, and the brake pads 60. The caliper 10 includes a piston bore 12, fingers 18, and a bridge 16 connecting the piston bore 12 and the bridge 16. The caliper 10 further includes a guide pin bore 24 and a pin bore 20. The piston bore 12 includes a horizontal axis 58, which bisects the piston bore 12 and is perpendicular to the piston bore axis (not shown). The piston bore 12 further includes a vertical axis 56 that vertically bisects the piston bore. The vertical axis 56 is perpendicular to both the horizontal axis 58 and the piston bore axis (not shown).

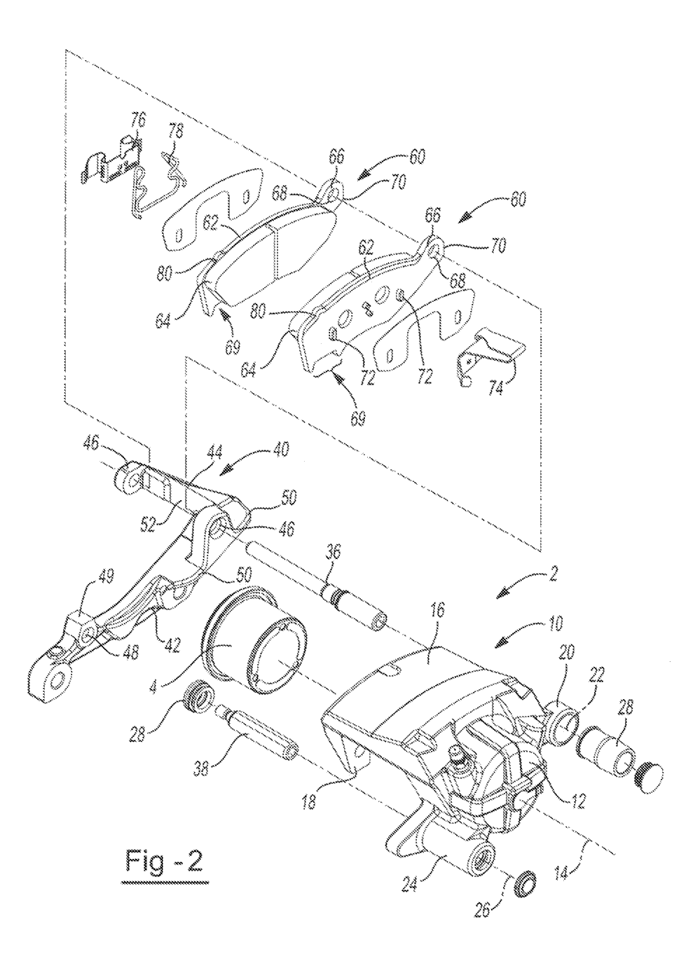

FIG. 2 illustrates an exploded view of one possible embodiment of the brake assembly 2. The caliper 10 includes a piston bore 12 with a piston 4 located in the piston bore 12, and the piston bore 12 includes a piston bore axis 14. The caliper 10 includes a bridge 16 connecting the piston bore 12 to the fingers 18. The caliper 10 includes a pin bore 20 and a pin 36, and the pin bore 20 includes a pin bore axis 22. The caliper 10 includes a guide pin bore 24 and a guide pin 38, and the guide pin bore 24 includes a guide pin bore axis 26. The pin bore 20 and the guide pin bore 24 as illustrated include a bushing 28. The guide pin bore 24 includes a groove (not shown). A support bracket 40 is illustrated. The support bracket 40 includes a tie arm 42 and a cross arm 44. The tie arm 42 includes a guide pin bore 48, shares one pin bore with the cross arm 44, and the cross arm 44 includes a second pin bore 46 in an end region. The support bracket 40 further includes ribs 50 on both the tie arm 42 and the cross arm 44. The support bracket includes an abutment 52 on the cross arm 44 between the pin bores 46. The support bracket includes a retention feature 49, which contacts an abutment feature 69 of a brake pad 60. The brake pads 60 include a pressure plate 62 and a friction member 64. The pressure plates 62 includes a support arm 66 and the support arm includes a pin bore 68 and an abutment 70. The pressure plate further includes two projections 72 and a locator 80. An outer clip 76 and an outer biasing clip 78 are connected to the outer brake pad 60 so that the outer brake pad is biased relative to the fingers 18 of the caliper 10. The inner brake pad 60 includes an inner clip 74 attached via the projections 72.

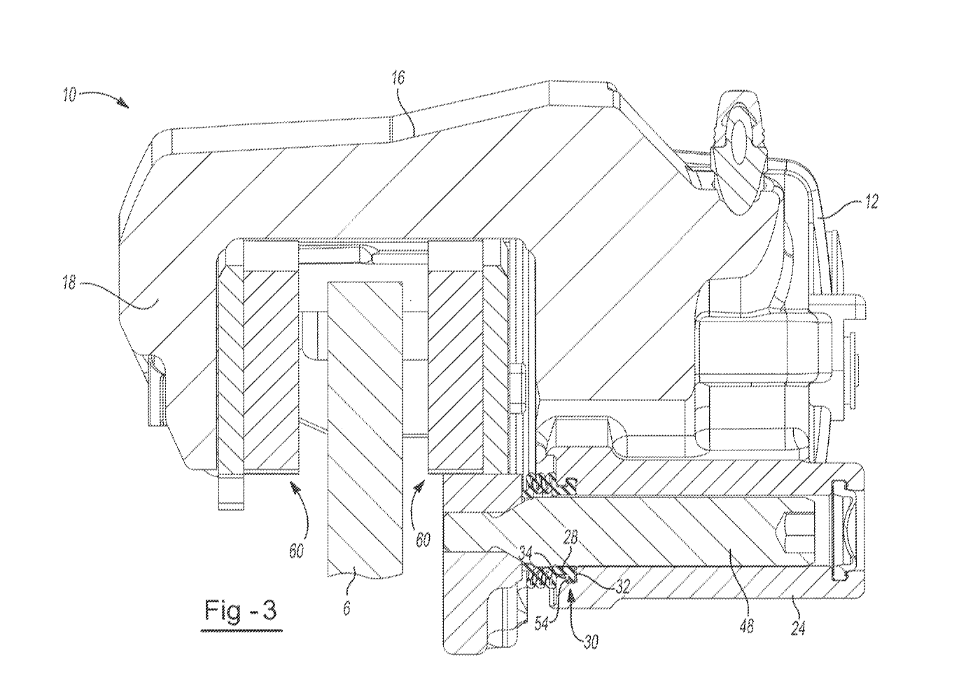

FIG. 3 illustrates a cross-sectional view of the caliper 10 cut along line 3 of FIG. 1. The caliper 10 includes a piston bore 12, fingers 18, and a bridge 16 connecting the piston bore 12 to the fingers 18. Brake pads 60 are located between the fingers 18 and the piston bore 12. A rotor 6 is located between the brake pads 60. A cross section of a guide pin bore 24 and the guide pin 48 shows a groove 30 in the guide pin bore 24. A bushing 28 is located in the groove 30 and the bushing 28 including a rib 54. The groove 30 includes an inner wall 32 and an outer wall 34.

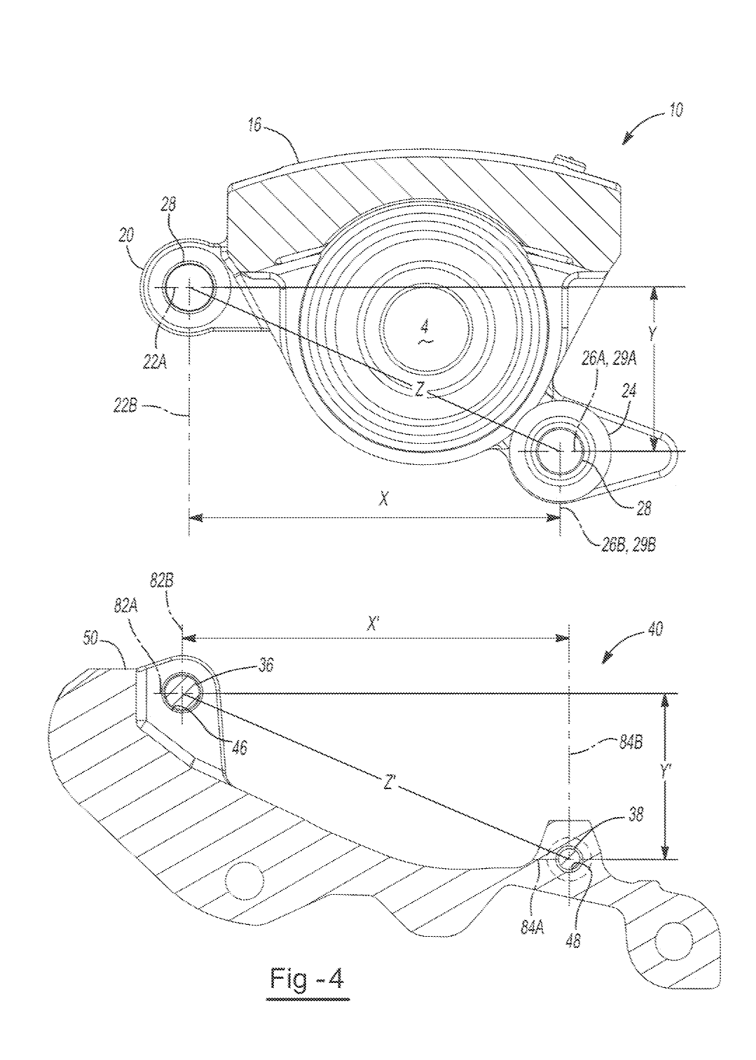

FIG. 4 illustrates a side view of the caliper 10 on the top of the page and a side view of the support bracket 40 on the bottom of the page. As illustrated the caliper 10 includes a pin bore 20, a guide pin bore 24, a bridge 16, and an end of the piston 4. The guide pin bore 24 includes a bushing 28. The guide pin bore 24 includes a first guide pin bore axis 26A and a second guide pin bore axis 26B. The first guide pin bore axis 26A and the second guide pin bore axis 26B overlap the first bushing axis 29A and the second bushing axis 29B respectively when the bushing is in the relaxed state. The pin bore 20 includes a bushing 28. The pin bore includes a first pin bore axis 22A and a second pin bore axis 22B. The support bracket 40 includes a pin bore 46 and a guide pin bore 48. As illustrated the pin bore 40 includes a pin 36 and the guide pin bore 40 includes a guide 38. The pin bore 40 includes a first pin bore axis 82A and a second pin bore axis 82B. The guide pin bore includes a first guide pin bore axis 84A and a second guide pin bore axis 84B. The horizontal distance between the second pin bore axis 22B and the second guide pin bore axis 26B of the caliper 10 has a horizontal distance (X). The horizontal distance between the second pin bore axis 82B and the second guide pin bore axis 84B of the support bracket has a horizontal distance (X′), which is greater than horizontal distance (X). The first pin bore axes 82A and 22A are located above the first guide pin bore axes 84A and 26A on both the support bracket 40 and the caliper 10. The first pin bore axis 22A of the caliper 10 is located a vertical distance (Y) above the first guide pin bore axis 26A of the caliper 10. The first pin bore axis 82A of the support bracket 40 is located a vertical distance (Y′) above the first guide pin bore axis 84A. The vertical distance (Y) of the support bracket is larger than the vertical distance (Y′) of the caliper. The caliper includes a straight line distance (Z) between the center of the pin bore 12 and the center of the guide pin bore 24. The support bracket includes a straight line distance (Z′) between the center of the pin bore 46 and the guide pin bore 48. The straight line distance (Z′) of the support bracket is larger than the straight line distance (Z) of the caliper.

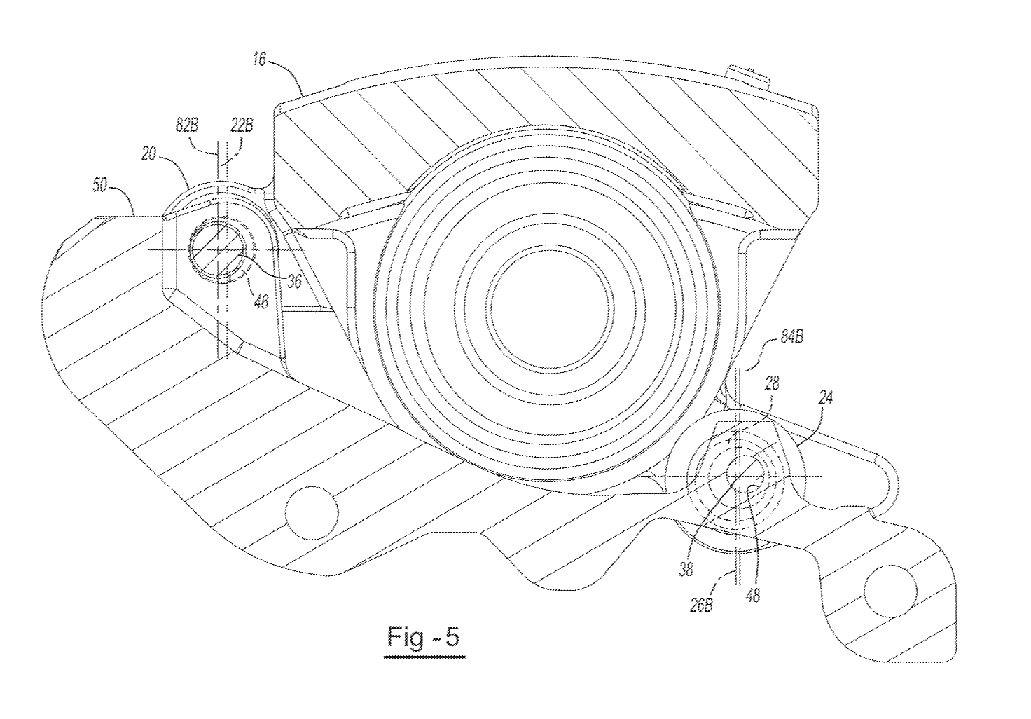

FIG. 5 illustrates the caliper 10 attached to the support bracket 40 via the pin 36 and guide pin 38. The second pin axis 22B of the caliper and the second pin axis 82B of the support bracket are substantially parallel; however, the axes do not overlap when the caliper 10 is attached to the support bracket 40. The pin 36 is moved so that the pin 36 contacts the outer edge of the pin bore 20 so that the guide pin 38 can be installed as shown. The guide pin 38 compresses the bushing 28 so that the bushing 28 is under a constant load. The reactionary force of the bushing maintains the pin 36 in contact with the outer wall of the caliper pin bore 20 so that the caliper body is accurately positioned on the support bracket. The second guide pin bore axis 26B of the caliper and the second guide pin bore axis 84B of the support bracket are parallel but do not overlap.

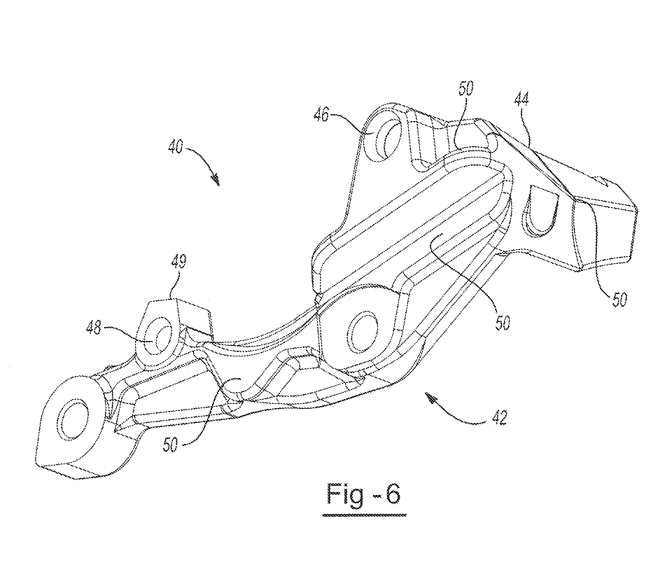

FIG. 6 includes a perspective view of the support bracket 40. The support bracket includes a tie arm 42 and a cross arm 44. The cross arm 44 includes an abutment, which is located between the two pin bores 46. One of the pin bores 46 is located at a connecting region between the tie arm 42 and the cross arm 44. The cross arm 44 includes a retention feature 49. The retention feature 49 substantially surrounds the guide pin bore 48 in the tie arm 42. The tie arm 42 and the cross arm 44 further include ribs 50. As illustrated, the connection region between the tie arm 42 and the cross arm 44 includes multiple ribs 50 so that the cross arm 44 is not moved away from the tie arm 42. The ribs 50 in the connection region span between the cross arm 44 and the tie arm 42 so that during a brake apply the ribs 50 substantially prevent the cross arm from moving relative to the tie arm 42.

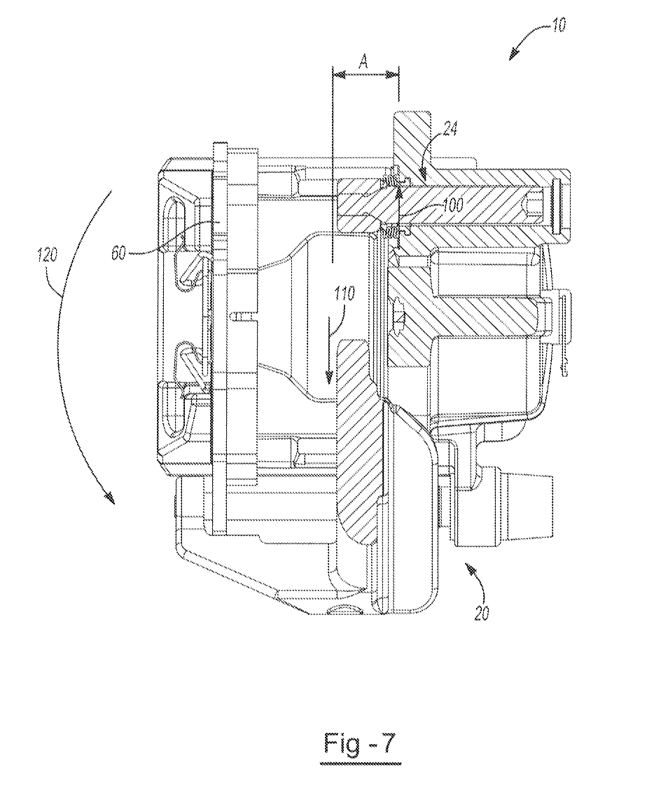

FIG. 7 illustrates the sag of a caliper 10, in the direction of the arrow 102, that does not include a bushing in the pin bore 20. The weight of the caliper 10 when installed on the support bracket 40 creates a sag on the caliper so that a force 100 is placed on the guide pin bore 24. The sag created by the weight of the caliper, indicated by arrow 110, acting over distance (A) causes angular misalignment between the face of the brake pads 60 and the rotor (not shown).

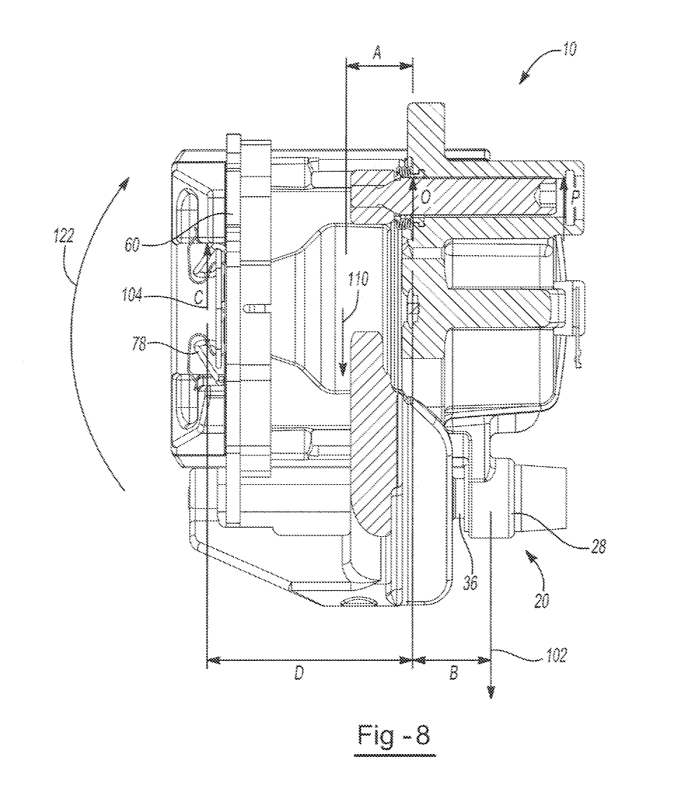

FIG. 8 illustrates the sag of the caliper 10 being counteracted, in a direction indicated by arrow 104, by the bushing 28 located in the pin bore 20. The bushing 28 pushes on the pin 36, in a direction as indicated by arrow 102, and generates a moment over a distance (B) that pulls the guide pin bore into contact with the top edge of the guide pin between points (O) and (P) so that the face of the brake pads 60 and the rotor (not shown) are maintained substantially in alignment. The upward force, indicated by arrow 104, from the biasing clip 78 at point (C) acts over a distance (D) that creates a moment that aligns the body of the caliper to the support bracket. The moments created by the bushing 28 and the biasing clip 78 combine to counteract the moment from the body weight of the caliper, indicated by arrow 110, so that the caliper and rotor are maintained in alignment.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

I claim:

1. A support bracket comprising:
a) a tie arm, the tie arm including:
i) a pin bore and
ii) a guide pin bore
b) a cross arm connected to the tie arm, the cross arm including a pin bore that is substantially axially aligned with the pin bore of the tie arm so that a pin can pass through both the tie arm pin bore and the cross arm pin bore;
wherein the tie arm includes ribs so that deflection of the tie arm is minimized and/or substantially eliminated during a brake apply.

2. The support bracket of claim 1, wherein the tie arm and the cross arm are substantially perpendicular.

3. The support bracket of claim 1, wherein the cross arm includes an abutment between the tie arm pin bore and the cross arm pin bore so that an abutment of at least one brake pad contacts the abutment during a brake apply so that forces applied to the at least one brake pad is transferred to the support bracket abutment.

4. The support bracket of claim 1, wherein the cross arm further includes ribs that connect with the ribs of the tie arm so that deflection of the cross arm is minimized and/or substantially eliminated during a brake apply.

5. The support bracket of claim 1, wherein the support bracket includes a retention feature adjacent to the guide pin bore and an inboard brake pad so that the inboard brake pad does not radially rotate towards the support bracket.

6. The support bracket of claim 1, wherein the support bracket includes pin bores on only one end of the support bracket.

7. The support bracket of claim 1, wherein the support bracket is free of a second tie arm.

8. The support bracket of claim 1, wherein the support bracket is free of a second cross arm.

9. The support bracket of claim 1, wherein the abutment of the support bracket has a shape that is complementary to the shape of the brake pads.

10. The support bracket of claim 2, wherein the cross arm includes an abutment between the tie arm pin bore and the cross arm pin bore so that an abutment of at least one brake pad contacts the abutment during a brake apply so that forces applied to the at least one brake pad is transferred to the support bracket abutment and the cross arm includes ribs that connect with the ribs of the tie arm so that deflection of the cross arm is minimized and/or substantially eliminated during a brake apply; and
wherein the support bracket is free of a second tie arm and a second cross arm.

11. A brake assembly comprising:
a) the support bracket of claim 1;
b) a pin;
c) a guide pin;
d) a brake pad in an outboard position and an inboard position;
e) a rotor located between the brake pad in the inboard position and the brake pad in the outboard position; and
f) a caliper;
wherein the caliper is attached to the support bracket with the pin, and the guide pin assists in maintaining the position of the caliper on the support bracket; and
further wherein the brake pad in the inboard position and the brake pad in the outboard position are located inside of the caliper and the pin passes through a bore in the inboard brake pad and a bore in the outboard brake pad so that the inboard brake pad and the outboard brake pad are attached to the brake assembly.

12. The brake assembly of claim 11, wherein the caliper comprises:
a) a piston bore;
b) one or more fingers;
c) a bridge connecting the piston bore and the one or more fingers;
d) a pin bore in the caliper;
e) a guide pin bore in the caliper, the guide pin bore including a groove; and
f) a bushing that extends into the guide pin bore so that a portion of the bushing is located inside of the guide pin bore and a portion of the bushing is located outside of the guide pin bore;
wherein the bushing further extends into the groove in the guide pin bore.

13. The brake assembly of claim 12, wherein the groove is located in an end region of the guide pin bore that is located proximate to the support bracket so that the portion of the bushing that is located outside of the guide pin bore is located between the guide pin bore and the support bracket.

14. The brake assembly of claim 13, wherein the bushing includes a rib for gripping a guide pin.

15. The brake assembly of claim 13, wherein the groove includes:
a) an inner wall and
b) an outer wall
wherein the outer wall is shorter than the inner wall so that the bushing extends around the wall and into the groove.

16. The brake assembly of claim 11, wherein the brake pad comprises:
a) a friction material and
b) a pressure plate, the pressure plate comprising:
i) a support arm that includes:
(1) a pin bore and
(2) an abutment on an end of the support arm; and
ii) one or more projections on a side of the pressure plate opposite the friction material.

17. The brake assembly of claim 16, wherein the abutment includes a complementary shape to the abutment of the support bracket so that during a brake apply the abutment of the brake pad is moved into contact with the abutment of the support bracket and rotation of the brake pad is minimized, eliminated, or both.

18. The brake assembly of claim 11, wherein thermal expansion of the brake pads during use does not affect the performance of the brake assembly.

19. The brake assembly of claim 11, wherein the brake assembly includes an outer biasing clip that biases the outboard brake pad down and forward away from the fingers of the caliper, and biases the fingers up so that the brake pad remains substantially parallel to a rotor assembly.

20. The brake assembly of claim 11, wherein the guide pin contacts only one side of the guide pin bore of the caliper, and is free of contact with a second side of the guide pin bore of the caliper.
